(19) United States
(12) Patent Application Publication
(10) Pub. No.: US 2025/0136363 A1
(43) Pub. Date: May 1, 2025

(54) Separable Trash Can Device

(71) Applicants: Cynthia Pavlovich, Fairlawn, OH (US); Ronald Pavlovich, Fairlawn, OH (US)

(72) Inventors: Cynthia Pavlovich, Fairlawn, OH (US); Ronald Pavlovich, Fairlawn, OH (US)

(21) Appl. No.: 18/612,520

(22) Filed: Mar. 21, 2024

Related U.S. Application Data
(60) Provisional application No. 63/594,551, filed on Oct. 31, 2023.

(51) Int. Cl. B65F 1/14

(52) U.S. Cl. CPC B65F 1/14

(57) ABSTRACT

A separable trash can device is provided. The device is comprised of a multi-part body. In one embodiment, the body has two halves designed to attach to each other using various types of fasteners. In another embodiment, the two halves are partially secured to each other via at least one hinge, wherein the halves can be secured to each other via at least one fastener. Additionally, one embodiment incorporates wheels for mobility.

### CROSS-REFERENCE TO RELATED APPLICATION

The present application claims priority to, and the benefit of, U.S. Provisional Application No. 63/594,551, which was filed on Oct. 31, 2023, and is incorporated herein by reference in its entirety.

### FIELD OF THE INVENTION

The present invention relates generally to the field of trash receptacles. More specifically, the present invention relates to a separable trash can device comprised of a separable, multi-piece trash can that facilitates easy cleaning. Accordingly, the present disclosure makes specific reference thereto. Nonetheless, it is to be appreciated that aspects of the present invention are also equally applicable to other like applications, devices, and methods of manufacture.

### BACKGROUND

Trash receptacles are a common fixture in homes, kitchens, offices, and various other settings, serving the essential function of managing waste. However, a significant issue arises from the standard one-piece design of trash receptacles, which complicates the cleaning process. More specifically, the inner surfaces and hard-to-reach corners of these receptacles often accumulate grime, food particles, and other debris, creating an environment conducive to the growth of mold and bacteria. Over time, this accumulation not only becomes a health hazard but also leads to the emission of unpleasant odors from the receptacle, making the space around it less welcoming and sanitary.

The task of cleaning one-piece trash receptacles is widely regarded as messy, unpleasant, and particularly frustrating. Many individuals dread the chore of scrubbing the bottom and corners of their bins, where waste residue tends to cling and harden. This aversion to cleaning is exacerbated by the design flaws of standard receptacles, which do not easily allow for thorough washing or drying, thereby perpetuating the cycle of bacterial growth and odor generation.

Moreover, when faced with a trash receptacle that is persistently difficult to clean and maintain, people's dissatisfaction may lead to several undesirable outcomes. Some might choose to tolerate the foul smell, compromising their living or working environment's cleanliness and hygiene. Others might resort to using excessive amounts of cleaning agents, which can be both economically and environmentally costly. In extreme cases, the frustration with an unmanageable cleaning process might drive individuals to prematurely dispose of their trash cans, opting to replace them entirely. This not only incurs additional expense but also contributes to environmental waste, as discarded receptacles add to landfill mass.

Therefore, there exists a long-felt need in the art for an improved trash receptacle. There also exists a long-felt need in the art for a separable trash can device. More specifically, there exists a long-felt need in the art for a separable trash can device that can be easily cleaned. In addition, there exists a long-felt need in the art for a separable trash can device that can be easily cleaned via a multi-piece construction.

The subject matter disclosed and claimed herein, in one embodiment thereof, comprises a separable trash can device. The device is comprised of a multi-part body. In one embodiment, the body has two halves designed to attach to each other using various types of fasteners. In another embodiment, the two halves are partially secured to each other via at least one hinge, wherein the halves can be secured to each other via at least one fastener. Additionally, one embodiment incorporates wheels for mobility.

In this manner, the separable trash can device of the present invention accomplishes all the foregoing objectives and provides an improved trash receptacle. More specifically, the device provides a trash can device that can be easily cleaned via a multi-piece construction. This allows the device to be partially and/or fully disassembled during cleaning.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a separable trash can device comprised of a body preferably comprised of a first half and a second half, wherein the body is comprised of an interior space. The first half may be comprised of at least one opening. In one embodiment, the opening can be covered by at least one lid.

In one embodiment, the first half of the body removably attaches to the second half of the body via at least one fastener such as, but not limited to, a tongue and groove fastener, a snap fastener, a clip, a screw, a latch, a clamp, a male fastener and a female fastener, a magnet, etc. In this manner, the first half can be separated from the second half such that both halves can be easily cleaned and/or placed into a dishwasher for cleaning.

In a second embodiment, the first half attaches to the second half via at least one hinge. This embodiment is also comprised of at least one wheel of any type. The first half attaches to the second half of the body via at least one fastener such as, but not limited to, a tongue and groove fastener, a snap fastener, a clip, a screw, a latch, a clamp, a male fastener and a female fastener, a magnet, etc. In this manner, the first half can be separated from the second half (while remaining connected via the hinge) such that both halves can be easily cleaned.

Either half of the body may also be comprised of at least one opening that provides a means for the trapped air to escape when a fresh bag is put into the body. When trash is thrown into the newly inserted trash bag the trapped air escapes through the slits quickly eliminating the ballooning of the trash bag.

The present invention is also comprised of a method of using the device. First, a device is provided comprised of a body comprised of a first half that removably attaches to a second half. Then, the first half can be attached to the second half and secured to the second half via at least one fastener. Next, a trash bag can be placed into the interior space. After a user removes a full trash bag from the body, the fastener can be released to allow the first half to separate from the second half. Then, all surfaces of the halves can be easily washed.

In a second method of using the device, a device is provided comprised of a body comprised of a first half connected to a second half via at least one hinge. Then, the first half can be secured to the second half via at least one fastener. Next, a trash bag can be placed into the interior space. After a user removes a full trash bag from the body, the fastener can be released to allow the first half to be partially separated from the second half (while the halves remain attached via the hinge). Then, all surfaces of the halves can be easily washed.

Accordingly, the separable trash can device of the present invention is particularly advantageous as it provides an improved trash receptacle. More specifically, the device provides a trash can device that can be easily cleaned via a multi-piece construction. This allows the device to be partially and/or fully disassembled during cleaning. In this manner, the separable trash can device overcomes the limitations of existing trash receptacles known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a separable trash can device of the present invention while attached in accordance with the disclosed architecture;

FIG. 2 illustrates a front view of one potential embodiment of a separable trash can device of the present invention while attached in accordance with the disclosed architecture;

FIG. 3 illustrates a rear view of one potential embodiment of a separable trash can device of the present invention while attached in accordance with the disclosed architecture;

FIG. 4 illustrates a side view of one potential embodiment of a separable trash can device of the present invention while partially separated in accordance with the disclosed architecture;

FIG. 5 illustrates a flowchart of a method of using one potential embodiment of a separable trash can device of the present invention in accordance with the disclosed architecture; and

FIG. 6 illustrates a flowchart of a method of using one potential embodiment of a separable trash can device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved trash receptacle. There also exists a long-felt need in the art for a separable trash can device. More specifically, there exists a long-felt need in the art for a separable trash can device that can be easily cleaned. In addition, there exists a long-felt need in the art for a separable trash can device that can be easily cleaned via a multi-piece construction.

The present invention, in one exemplary embodiment, is comprised of a separable trash can device. The device is comprised of a body preferably comprised of a first half and a second half, wherein the body is comprised of an interior space. The first half may be comprised of at least one opening. In one embodiment, the opening can be covered by at least one lid.

In one embodiment, the first half of the body removably attaches to the second half of the body via at least one fastener such as, but not limited to, a tongue and groove fastener, a snap fastener, a clip, a screw, a latch, a clamp, a male fastener and a female fastener, a magnet, etc. In this manner, the first half can be separated from the second half such that both halves can be easily cleaned and/or placed into a dishwasher for cleaning. In a second embodiment, the first half attaches to the second half via at least one hinge. This embodiment is also comprised of at least one wheel of any type. The first half attaches to the second half of the body via at least one fastener such as, but not limited to, a tongue and groove fastener, a snap fastener, a clip, a screw, a latch, a clamp, a male fastener and a female fastener, a magnet, etc. In this manner, the first half can be separated from the second half (while remaining connected via the hinge) such that both halves can be easily cleaned.

Either half of the body may also be comprised of at least one opening that provides a means for the trapped air to escape when a fresh bag is put into the body. When trash is thrown into the newly inserted trash bag the trapped air escapes through the slits quickly eliminating the ballooning of the trash bag.

The present invention is also comprised of a method of using the device. First, a device is provided comprised of a body comprised of a first half that removably attaches to a second half. Then, the first half can be attached to the second half and secured to the second half via at least one fastener. Next, a trash bag can be placed into the interior space. After a user removes a full trash bag from the body, the fastener can be released to allow the first half to separate from the second half. Then, all surfaces of the halves can be easily washed.

In a second method of using the device, a device is provided comprised of a body comprised of a first half connected to a second half via at least one hinge. Then, the first half can be secured to the second half via at least one fastener. Next, a trash bag can be placed into the interior space. After a user removes a full trash bag from the body, the fastener can be released to allow the first half to be partially separated from the second half (while the halves remain attached via the hinge). Then, all surfaces of the halves can be easily washed.

Accordingly, the separable trash can device of the present invention is particularly advantageous as it provides an improved trash receptacle. More specifically, the device provides a trash can device that can be easily cleaned via a multi-piece construction. This allows the device to be partially and/or fully disassembled during cleaning. In this manner, the separable trash can device overcomes the limitations of existing trash receptacles known in the art.

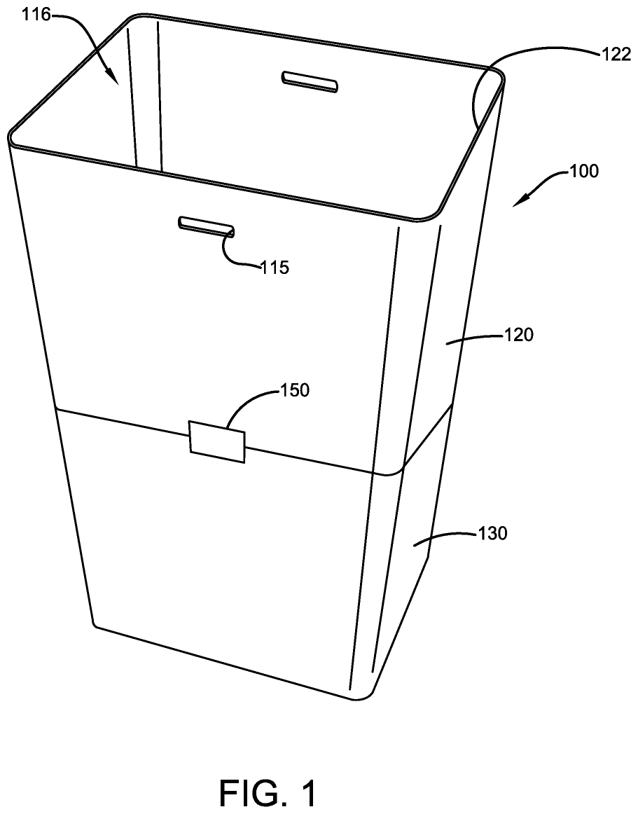

Referring initially to the drawings, FIG. 1 illustrates a perspective view of one potential embodiment of a separable trash can device 100 of the present invention while attached in accordance with the disclosed architecture. The device 100 is comprised of a body 110 preferably comprised of a first half 120 and a second half 130, wherein the body 110 is comprised of an interior space 116. The body 110 may be made from any material such as, but not limited to, plastic or metal. The material of the body 110 is preferably washable (i.e., dishwasher safe). The body 110 may be any size, shape, capacity, and configuration of trash can body 110 to allow the body 110 to be used in a commercial or residential application.

The body 110 is comprised of at least two halves 120, 130. The first half 120 may be comprised of at least one opening 122. In one embodiment, the opening 122 can be covered by at least one lid 112. The lid 112 may be any lid style and may attach to the first half 120 via at least one hinge 113. In another embodiment, the lid 112 fits over the first half 120 without using a hinge 113. The lid 112 may also be comprised of at least one handle 114 of any type/style.

In one embodiment, the first half 120 of the body 110 removably attaches to the second half 130 of the body 110 via at least one fastener 150 such as, but not limited to, a tongue and groove fastener, a snap fastener, a clip, a screw, a latch, a clamp, a male fastener and a female fastener, a magnet, etc. In this manner, the first half 120 can be separated from the second half 130 such that both halves 120, 130 can be easily cleaned and/or placed into a dishwasher for cleaning. In one embodiment, the first half 120 may be tapered to be received by the second half 130. The fastener 150 may be positioned internally and/or externally on the body 110.

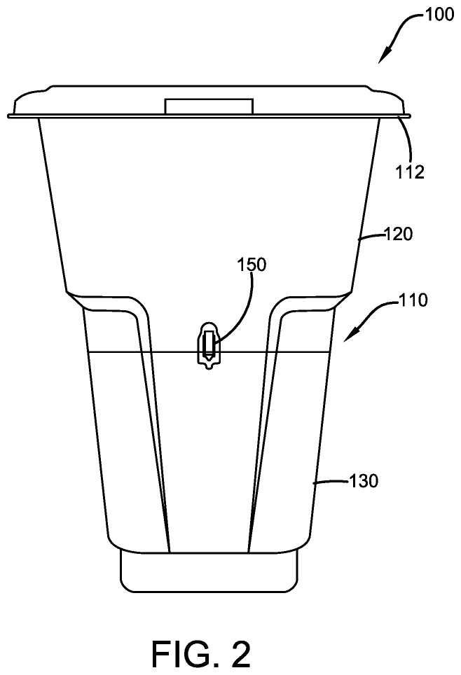

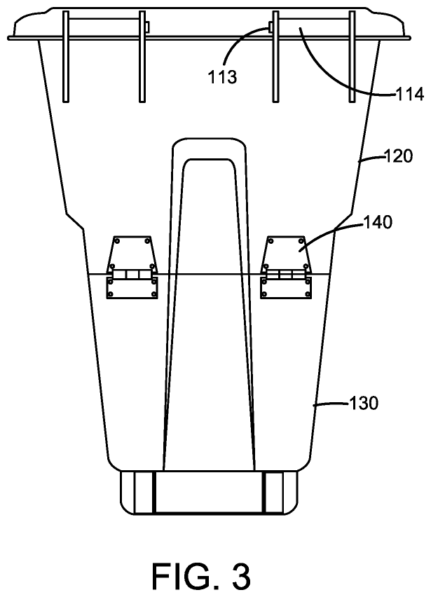

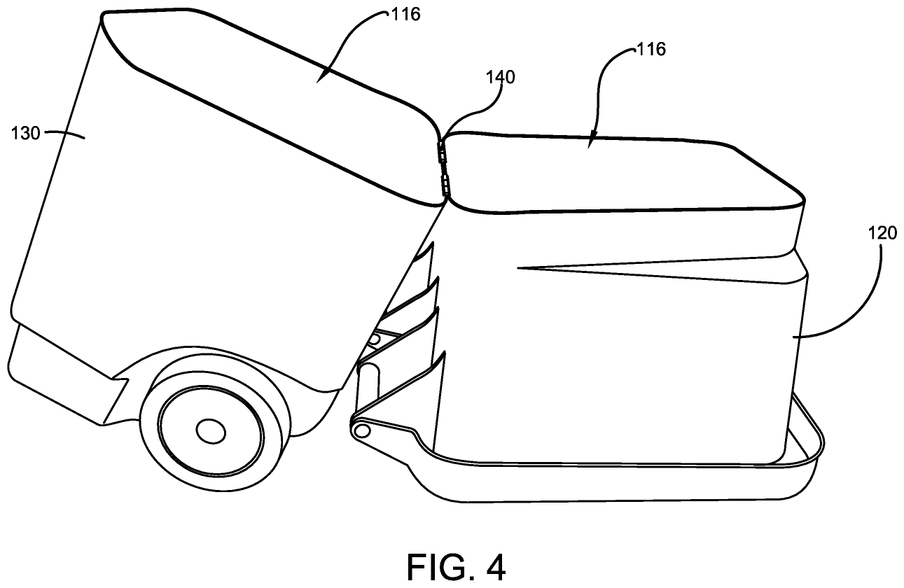

In a second embodiment, the first half 120 attaches to the second half 130 via at least one hinge 140, as seen in FIG. 3. This embodiment is also comprised of at least one wheel 111 of any type. The first half 120 attaches to the second half 130 of the body 110 via at least one fastener 150 such as, but not limited to, a tongue and groove fastener, a snap fastener, a clip, a screw, a latch, a clamp, a male fastener and a female fastener, a magnet, etc., as seen in FIG. 2. In this manner, the first half 120 can be partially separated from the second half 130 (while remaining connected via the hinge 140) such that both halves 120, 130 can be easily cleaned, as seen in FIG. 4. The fastener 150 may be positioned internally and/or externally on the body 110.

Either half 120, 130 of the body 110 may also be comprised of at least one opening 115. The opening 115 provides a means for the trapped air to escape when a fresh bag is put into the body 110. When trash is thrown into the newly inserted trash bag the trapped air escapes through the slits quickly eliminating the ballooning of the trash bag.

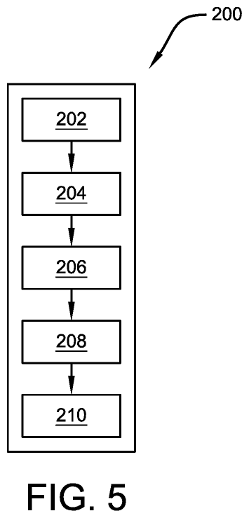

The present invention is also comprised of a method of using 200 the device 100, as seen in FIG. 5. First, a device 100 is provided comprised of a body 110 comprised of a first half 120 that removably attaches to a second half 130 [Step 202]. Then, the first half 120 can be attached to the second half 130 and secured to the second half 130 via at least one fastener 150 [Step 204]. Next, a trash bag can be placed into the interior space 116 [Step 206]. After a user removes a full trash bag from the body 110, the fastener 150 can be released to allow the first half 120 to separate from the second half 130 [Step 208]. Then, all surfaces of the halves 120, 130 can be easily washed [Step 210].

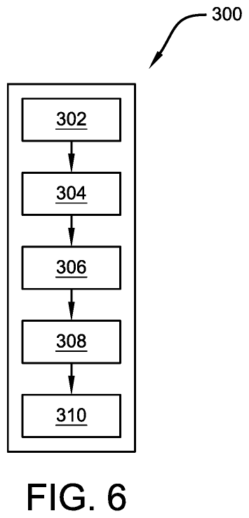

The present invention is also comprised of a second method of using 300 the device 100, as seen in FIG. 6. First, a device 100 is provided comprised of a body 110 comprised of a first half 120 connected to a second half 130 via at least one hinge 140 [Step 302]. Then, the first half 120 can be secured to the second half 130 via at least one fastener 150 [Step 304]. Next, a trash bag can be placed into the interior space 116 [Step 306]. After a user removes a full trash bag from the body 110, the fastener 150 can be released to allow the first half 120 to be partially separated from the second half 130 (while the halves 120, 130 remain attached via the hinge 140) [Step 308]. Then, all surfaces of the halves 120, 130 can be easily washed [Step 310].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “separable trash can device” and “device” are interchangeable and refer to the separable trash can device 100 of the present invention.

Notwithstanding the foregoing, the separable trash can device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the separable trash can device 100 as shown in the FIGS. are for illustrative purposes only, and that many other sizes and shapes of the separable trash can device 100 are well within the scope of the present disclosure. Although the dimensions of the separable trash can device 100 are important design parameters for user convenience, the separable trash can device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A separable trash can device comprising:
a body comprised of a first half and a second half;
a fastener;
a first opening; and
a second opening.

2. The separable trash can device of claim 1, wherein the first half attaches to the second half.

3. The separable trash can device of claim 2, wherein the first half is secured to the second half via the fastener.

4. The separable trash can device of claim 3, wherein the fastener is comprised of a tongue and groove fastener, a snap fastener, a clip, a screw, a latch, a clamp, a male fastener and a female fastener, or a magnet.

5. The separable trash can device of claim 1, wherein the fastener is positioned internally on the body.

6. The separable trash can device of claim 1 further comprised of a lid.

7. The separable trash can device of claim 6, wherein the lid attaches to the first half via a hinge.

8. The separable trash can device of claim 6, wherein the lid is comprised of a handle.

9. A separable trash can device comprising:
a body comprised of a first half and a second half;
a first hinge;
a fastener;
a first opening; and
a second opening.

10. The separable trash can device of claim 9, wherein the first half attaches to the second half via the hinge.

11. The separable trash can device of claim 10, wherein the first half is secured to the second half via the fastener.

12. The separable trash can device of claim 11, wherein the fastener is comprised of a tongue and groove fastener, a snap fastener, a clip, a screw, a latch, a clamp, a male fastener and a female fastener, or a magnet.

13. The separable trash can device of claim 9, wherein the fastener is positioned externally on the body.

14. The separable trash can device of claim 9 further comprised of a lid.

15. The separable trash can device of claim 14, wherein the lid attaches to the first half via a second hinge.

16. The separable trash can device of claim 14, wherein the lid is comprised of a handle.

17. The separable trash can device of claim 9 further comprised of a wheel.

18. A method of using a separable trash can device, the method comprising the following steps:
providing a separable trash can device comprised of a body comprised of a first half that removably attaches to a second half;
attaching the first half to the second half via a fastener;
placing a trash bag into an interior space of the body;
removing the trash bag from the body and releasing the fastener to separate the first half from the second half; and
washing the first half and the second half.

19. The method of using a separable trash can device of claim 18, wherein the first half attaches to the second half via a hinge.

20. The method of using a separable trash can device of claim 18, wherein the first half is comprised of a lid and a wheel.
